(19) United States
(12) Patent Application Publication
(10) Pub. No.: US 2026/0179955 A1
(43) Pub. Date: Jun. 25, 2026

(54) BINDER COMPOSITION FOR LITHIUM SECONDARY BATTERY NEGATIVE ELECTRODE, LITHIUM SECONDARY BATTERY NEGATIVE ELECTRODE COMPRISING THE SAME AND LITHIUM SECONDARY BATTERY COMPRISING THE SAME

(71) Applicants: HYUNDAI MOTOR COMPANY, Seoul (KR); KIA CORPORATION, Seoul (KR); INCHEON NATIONAL UNIVERSITY RESEARCH & BUSINESS FOUNDATION, Incheon (KR)

(72) Inventors: Taerim Lee, Hwaseong-si (KR); Yongho Lee, Hwaseong-si (KR); Yumi Kang, Incheon (KR); Jonghyeok Han, Incheon (KR); Seojin Yeon, Incheon (KR); Jun Won Heo, Incheon (KR); Ji Seong Heo, Incheon (KR); Sae Chan Yoon, Incheon (KR); Taeeun Yim, Incheon (KR); Tae-Hyun Kim, Incheon (KR); Sangwook Kim, Goyang-si (KR)

(73) Assignees: HYUNDAI MOTOR COMPANY, Seoul (KR); KIA CORPORATION, Seoul (KR); INCHEON NATIONAL UNIVERSITY RESEARCH & BUSINESS FOUNDATION, Incheon (KR)

(21) Appl. No.: 19/169,478

(22) Filed: Apr. 3, 2025

(30) Foreign Application Priority Data
Dec. 24, 2024 (KR) 10-2024-0195272

(51) Int. Cl. H01M 4/62; H01M 4/02; H01M 4/133; H01M 4/134; H01M 4/36; H01M 4/48; H01M 4/583; H01M 10/052

(52) U.S. Cl. CPC H01M 4/622; H01M 4/133; H01M 4/134; H01M 4/364; H01M 4/483; H01M 4/583; H01M 4/625; H01M 10/052; H01M 2004/027

(57) ABSTRACT

A binder composition for a lithium secondary battery negative electrode comprising carboxymethylcellulose (CMC) and an additive comprising polydopamine (PDA) and glutathione (GT), a lithium secondary battery negative electrode comprising the same, and a lithium secondary battery comprising the same.

### CROSS-REFERENCE TO RELATED APPLICATION

This present application claims the benefit of priority to Korean Patent Application No. 10-2024-0195272, entitled “BINDER COMPOSITION FOR LITHIUM SECONDARY BATTERY NEGATIVE ELECTRODE, LITHIUM SECONDARY BATTERY NEGATIVE ELECTRODE COMPRISING THE SAME AND LITHIUM SECONDARY BATTERY COMPRISING THE SAME” filed on Dec. 24, 2024, in the Korean Intellectual Property Office, the entire disclosure of which is incorporated herein by reference.

### FIELD

The present disclosure relates to a binder composition for a lithium secondary battery negative electrode comprising carboxymethylcellulose (CMC) and an additive comprising polydopamine (PDA) and glutathione (GT), a lithium secondary battery negative electrode comprising the same, and a lithium secondary battery comprising the same.

### BACKGROUND

With the development of the secondary battery industry, lithium secondary batteries (LIBs) are widely used in various fields, such as portable electronic products, electric vehicles, and energy storage devices. Graphite, as a carbon-based material, is currently used as a negative electrode of the lithium secondary battery. However, these graphite-based negative electrodes have technical challenges including, for example, that its low theoretical capacity makes it difficult to utilize in applications when a high energy density is required. One approach to address this problem has focused research on silicon-based negative electrode materials. Silicon may provide a theoretical capacity that is about 10 times higher than that of graphite, which may greatly improve the energy density of the battery.

However, silicon presents a challenge in that it causes a volume expansion of about 300% during the intercalation and deintercalation of lithium ions, which causes structural deterioration of the silicon-based negative electrode. As a result, a thick solid electrolyte interface (SEI) may be formed, which may significantly reduce the lifespan and stability of the electrode. This problem has made the commercialization of silicon-based negative electrodes difficult.

One way to address the expansion issue associated with silicon materials is to develop a multifunctional polymer binder capable of suppressing and buffering the volume change of silicon. Such binders may maintain the adhesion between electrode components, improve electrochemical performance, and alleviate electrode damage caused by silicon volume expansion.

Recently, an attempt has been made to improve electrochemical performance by adding an additive to carboxymethylcellulose (CMC), a commercialized binder material. To date, however, approaches using additive-CMC binders have been unsuccessful in that they have exhibited reduced adhesive properties. Further, the addition of other additives to improve the adhesive properties have resulted in other issues such as increases in electrical resistance or failure to adequately modulate the silicon volume expansion.

Therefore, there remains a need for binders that improve the adhesive properties between electrode components while using a silicon-based negative electrode and maximize electrochemical or mechanical properties.

### SUMMARY

The present disclosure addresses the above-described problems in the prior art. In a general aspect, the disclosure provides a binder composition for a lithium secondary battery negative electrode that exhibits excellent adhesion between electrode components while improving electrochemical and mechanical properties. Other aspects provide a lithium secondary battery negative electrode comprising the same, and a lithium secondary battery comprising the same.

In the above aspects, the present disclosure provides a binder composition for a lithium secondary battery negative electrode that may comprise carboxymethylcellulose (CMC), and an additive comprising polydopamine (PDA) and glutathione (GT).

In another aspect, the present disclosure provides a lithium secondary battery negative electrode that may comprise a binder comprising the binder composition for the lithium secondary battery negative electrode according to various embodiments of the present disclosure; a conductive material; and a negative electrode active material.

In a further aspect, the present disclosure provides a lithium secondary battery that may comprise the lithium secondary battery negative electrode according to various embodiments of the present disclosure.

According to some embodiments of the disclosure, the binder composition for the lithium secondary battery negative electrode may comprise an additive comprising polydopamine and glutathione. As described herein, an additive comprising polydopamine and glutathione can improve adhesion and provide strong bonding strength with a current collector.

As further described herein, binder compositions in accordance with the disclosure can provide for increased elasticity (flexibility) and reduce stress due to any volume change of silicon in the lithium secondary battery negative electrode.

In additional embodiments of the present disclosure, when graphite is included in the lithium secondary battery negative electrode, it is possible to improve cycle characteristics of the electrode through the interaction between the binder composition of the present disclosure and graphite.

The lithium secondary battery negative electrode according to the present disclosure can be manufactured by an aqueous process and may be more environmentally friendly than existing manufacturing processes.

In additional embodiments, the materials described herein can provide for electrodes and batteries having improved capacity and excellent cycle characteristics.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 illustrates a chemical structure schematically showing a binder composition for a lithium secondary battery negative electrode according to an example embodiment of the disclosure;

FIG. 2 shows results of elasticity measurement according to Experimental Example 1;

FIG. 3 shows results of adhesion measurement according to Experimental Example 1;

FIG. 4 shows results of elastic modulus measurement according to Experimental Example 2;

FIG. 5 shows results of hardness measurement according to Experimental Example 2;

FIG. 6 shows electrochemical properties of Comparative Example 1 and Examples 1 to 3 according to Experimental Example 3;

FIG. 7 shows electrochemical properties of Comparative Examples 1 to 3 and Example 1 according to experimental example 3;

FIG. 8 shows results of elasticity measurement according to Experimental Example 4;

FIG. 9 shows electrochemical properties of Examples 1 and 4 according to Experimental Example 4;

FIG. 10 shows rate characteristics of Example 4 according to Experimental Example 4;

FIG. 11 is an SEM image of Example 4 according to Experimental Example 4;

FIG. 12 shows capacity characteristics at a charge rate of 0.2 C and a discharge rate of 0.5 C according to Experimental Example 5;

FIG. 13 shows capacity retention rates at a charge rate of 0.2 C and a discharge rate of 0.5 C according to Experimental Example 5;

FIG. 14 shows capacity characteristics at a charge rate of 0.4 C and a discharge rate of 1.0 C according to Experimental Example 5;

FIG. 15 shows capacity retention rates at a charge rate of 0.4 C and a discharge rate of 1.0 C according to Experimental Example 5;

FIG. 16 is an SEM image of Comparative Example 5 according to Experimental Example 6; and

FIG. 17 is an SEM image of Example 5 according to Experimental Example 6.

### DETAILED DESCRIPTION

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used herein are used for describing particular embodiments only and are not intended to limit the present disclosure. A singular expression includes a plural expression unless otherwise defined differently in a context. In the present disclosure, it should be understood that term “comprising” or “having” or “including” indicates that a feature, a number, a step, an operation, a component, a part or a combination thereof described in the specification is present, but does not exclude a possibility of presence or addition of one or more other features, numbers, steps, operations, components, parts or combinations thereof, in advance. It will be appreciated that those terms are also inclusive of the term “consisting of” or “consisting essentially of” which, when used throughout the disclosure or claims, generally indicate that a feature, a number, a step, an operation, a component, a part or a combination thereof described in the specification is present, and does not include any additional feature(s).

In an aspect, the disclosure provides a binder composition for a lithium secondary battery negative electrode comprising carboxymethylcellulose (CMC), and an additive comprising polydopamine (PDA) and glutathione (GT).

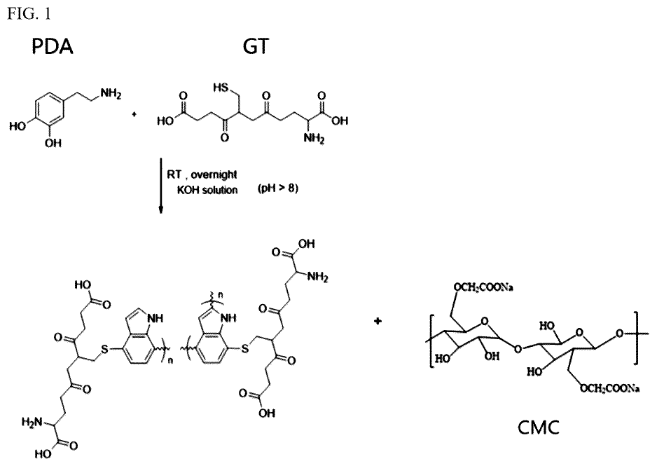

In embodiments, the additive components, (e.g., polydopamine and glutathione), may form a chemical bond to provide a compound. In such embodiments, the bonded compound may be physically mixed with carboxymethylcellulose, as shown, for example, in the example schematic depiction of the chemical structures in FIG. 1.

Embodiments wherein the binder composition for the lithium secondary battery negative electrode comprises carboxymethylcellulose allow for the use of water as a solvent, and an aqueous-based manufacturing process. Accordingly, the binder composition and methods of its production may be environmentally friendly or at least more environmentally friendly than existing production methods.

Embodiments wherein the binder composition for the lithium secondary battery negative electrode comprises polydopamine and glutathione as the additive allow for improved adhesion between components in the electrode. In addition, when graphite is included in the lithium secondary battery negative electrode, the polydopamine of the additive may improve the life characteristics of the electrode through π-π interaction with the graphite.

The binder composition for the lithium secondary battery negative electrode according to an embodiment of the present disclosure may comprise 5 to 20 wt % of the additive based on the total weight of the composition. In accordance with some of the example comparative embodiments described herein, it may be that when the additive is included in less than the above range, the effects of improving the adhesion and the electrochemical properties may be insignificant. In similar example comparative embodiments, it may be that when the additive is included in more than the above range, the dispersibility of the additive may be reduced, and the adhesion and mechanical properties may be reduced due to increased hydrogen bonding.

In some embodiments, the additive may comprise polydopamine and glutathione in a weight ratio of 1:1.5 to 2:1 (polydopamine: glutathione).

The binder composition for the lithium secondary battery negative electrode according to another embodiment of the present disclosure may further comprise styrene butadiene rubber (SBR). In such embodiments, the SBR can be amenable to aqueous processes (i.e., using water as a solvent), much like carboxymethylcellulose.

In another aspect, the lithium secondary battery negative electrode according to the present disclosure may comprise a binder comprising the binder composition for the lithium secondary battery negative electrode described above, a conductive material, and a negative electrode active material.

In an embodiment, the negative electrode active material may comprise silicon oxide (SiOx).

According to an embodiment, the lithium secondary battery negative electrode may comprise a negative electrode active material comprising silicon oxide (SiOx). When the negative electrode active material comprises only silicon oxide (SiOx) without an additional carbon material, the lithium secondary battery negative electrode may have a relatively high capacity.

In an embodiment, the binder included in the lithium secondary battery negative electrode may comprise the binder composition described above which can prevent volume expansion of silicon in the lithium secondary battery negative electrode after repeated charge and discharge.

In an embodiment, the conductive material may be carbon black (CB), and in some specific embodiments, the carbon black may be Super C.

In yet another embodiment of the present disclosure, the negative electrode active material may further comprise at least one carbon material such as, for example, silicon carbide (SiC), artificial graphite (AG), and natural graphite (NG).

According to yet another embodiment of the present disclosure, the lithium secondary battery negative electrode may comprise a negative electrode active material comprising silicon oxide (SiOx), silicon carbide, artificial graphite, and natural graphite. Accordingly, the negative electrode active material may form a silicon-carbon composite, thereby improving the initial charge and discharge efficiency and relieving the volume expansion of silicon.

In some further embodiments, the conductive material may comprise at least one of carbon black (CB) and single-walled carbon nanotubes (SWCNT), and in yet further embodiments, the carbon black may be Super C. In some embodiments, the conductive material may comprise carbon black (CB) and single-walled carbon nanotubes (SWCNT). In some example embodiments, the carbon black and the single-walled carbon nanotube may be included in a ratio of 1:0.05 to 1:0.15, where the ratios refer to the carbon black: carbon nanotube.

As noted above and further described herein, the binder included in the lithium secondary battery negative electrode may comprise the binder composition described herein that can reduce and/or prevent the volume expansion of silicon in the lithium secondary battery negative electrode after repeated charge and discharge.

In one example embodiment, the binder may further comprise styrene butadiene rubber (SBR). In some further embodiments, the binder may comprise the binder composition for the lithium secondary battery negative electrode and the styrene butadiene rubber (SBR) in a molar ratio of 1:1 to 1:3.

In another aspect, the disclosure provides a lithium secondary battery comprising a positive electrode, a separator, and the lithium secondary battery negative electrode according to various embodiments described herein. In embodiments, the positive electrode and the separator are a positive electrode and a separator as are known and used in conventional lithium secondary batteries, and are not limited to any one type.

As discussed herein, by comprising the lithium secondary battery negative electrode in accordance the disclosure, the lithium secondary battery may have excellent capacity and cycle characteristics.

In an effort to provide exemplary illustrations of the disclosed aspects and embodiments, several Examples in accordance with the present disclosure are described in more detail. However, it will be appreciated that the following Examples and Experimental Examples are only intended to illustrate and detail the disclosure, and do not serve to limit the scope of the present disclosure or the appended claims.

### Example 1

In order to manufacture a lithium secondary battery negative electrode, a binder solution was first prepared.

First, polydopamine (PDA) and glutathione (GT) were placed in an air-tight flask at a weight ratio of 1:1, respectively, to which was added a KOH aqueous solution adjusted to a pH of 8-9 to form a mixture. The mixture was stirred for up to 24 hours to prepare a binder additive for a lithium secondary battery negative electrode. The prepared additive was added at 10 wt % and mixed with a carboxymethylcellulose (CMC) aqueous solution without any separate purification process. After initial mixing, the temperature of the resulting solution was raised to 75° C. and stirred for 4 hours to prepare a binder solution.

A lithium secondary battery negative electrode was manufactured using the binder prepared above. The weight ratio of a negative electrode active material, a conductive material, and a binder was prepared as 8:1:1, using SiOx as the negative electrode active material, and Super C as the conductive material. The prepared negative electrode active material, conductive material, and binder were uniformly stirred and dispersed using a phase mixer to prepare a slurry.

Thereafter, the prepared slurry was coated on a current collector using a doctor blade. The coated current collector was dried at 120° C. for 10 minutes, and then rolled to a composite density of 1.5 g/cm³. Finally, the lithium secondary battery negative electrode was manufactured by vacuum drying at 120° C. for 3 hours. At this time, an electrode loading level was 1.5 mg/cm².

### Example 2

A lithium secondary battery negative electrode was manufactured in the same manner as Example 1, except that when the binder solution was prepared, 5 wt % of the additive was mixed with a carboxymethylcellulose (CMC) aqueous solution.

### Example 3

A lithium secondary battery negative electrode was manufactured in the same manner as Example 1, except that when the binder solution was prepared, 20 wt % of the additive was mixed with a carboxymethylcellulose (CMC) aqueous solution.

### Example 4

A lithium secondary battery negative electrode was manufactured in the same manner as Example 1, except that when the binder additive was prepared, polydopamine (PDA) and glutathione (GT) were added at a weight ratio of 2:1.

### Example 5

In order to manufacture a lithium secondary battery negative electrode, the binder solution prepared in Example 1 was first prepared.

The binder solution prepared in Example 1 was mixed with styrene butadiene rubber (SBR) at a weight ratio of 1:2 and used as a binder.

A lithium secondary battery negative electrode was manufactured using the SBR-containing binder prepared above. The weight ratio of the negative electrode active material, the conductive material, and the binder was prepared as 95.75:1.1:3, and the negative electrode active material used at this time included SiC, SiOx, artificial graphite (AG), and natural graphite (NG), in weight percent amounts of 11.01 wt % of SiC, 17.71 wt % of SiOx, 49.00 wt % of artificial graphite, and 21.00 wt % of natural graphite.

Single-Walled Carbon Nano Tube (SWCNT) and Super C were used as the conductive material at a ratio of 0.1:1, respectively. The prepared negative electrode active material, conductive material, and binder were uniformly stirred and dispersed using a phase mixer to prepare a slurry.

Thereafter, the prepared slurry was coated on a current collector using a doctor blade. The coated current collector was dried at 120° C. for 10 minutes, and then rolled to a composite density of 1.5 g/cm³. Finally, the lithium secondary battery negative electrode was manufactured by vacuum drying at 120° C. for 3 hours. At this time, an electrode loading level was 8 mg/cm².

### Comparative Example 1

In order to manufacture a lithium secondary battery negative electrode, a negative electrode active material, a conductive material, and a binder were prepared.

In this comparative example, the lithium secondary battery negative electrode was manufactured in the same manner as in Example 1, except that only a carboxymethylcellulose (CMC) aqueous solution was used as a binder.

### Comparative Example 2

In order to manufacture a lithium secondary battery negative electrode, a negative electrode active material, a conductive material, and a binder were prepared.

In this comparative example, the lithium secondary battery negative electrode was manufactured in the same manner as Example 1, except that only polydopamine (PDA) was prepared as a binder additive, and 10 wt % of PDA was mixed with a carboxymethylcellulose (CMC) aqueous solution.

### Comparative Example 3

In order to manufacture a lithium secondary battery negative electrode, a negative electrode active material, a conductive material, and a binder were prepared.

In this comparative example, the lithium secondary battery negative electrode was manufactured in the same manner as Example 1, except that only glutathione (GT) was prepared as a binder additive, and 10 wt % of GT was mixed with a carboxymethylcellulose (CMC) aqueous solution.

### Comparative Example 4

In this comparative example, a lithium secondary battery negative electrode was manufactured in the same manner as Example 1, except that when a binder additive was prepared, polydopamine (PDA) and glutathione (GT) were added at a weight ratio of 1:2.

### Comparative Example 5

In order to manufacture a lithium secondary battery negative electrode, a negative electrode active material, a conductive material, and a binder were prepared.

In this comparative example, the lithium secondary battery negative electrode was manufactured in the same manner as in Example 5, except that a carboxymethylcellulose (CMC) aqueous solution was mixed with styrene butadiene rubber (SBR) in a weight ratio of 1:2 to be used as a binder.

### Experimental Example 1

In this experiment, elasticity (flexibility) and adhesiveness were evaluated for Comparative Examples 1 and 2, and Examples 1 to 3.

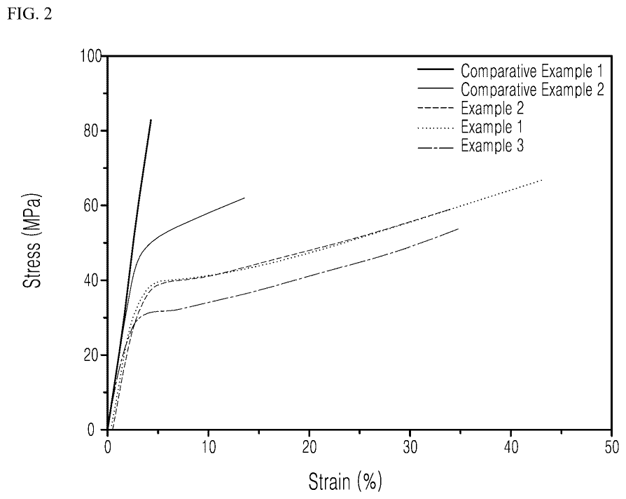

First, a tensile test was performed to measure the elasticity of the Comparative Examples and Examples, and the results are shown in FIG. 2.

Referring to the Stress-Strain graph as illustrated in FIG. 2, it may be seen that the elasticity (or flexibility) of Examples 1 to 3 is superior to that of Comparative Examples 1 and 2. Specifically, it may be seen through comparison with Comparative Example 1 that the properties are improved when an additive is included, and it was confirmed that the properties may be further improved when glutathione was further included even among the additives. Without being limited by mechanism, it may be that the improvement in elastic properties is due at least in part to the presence of a plurality of hydrogen bonding sites that may be introduced when both polydopamine and glutathione are included.

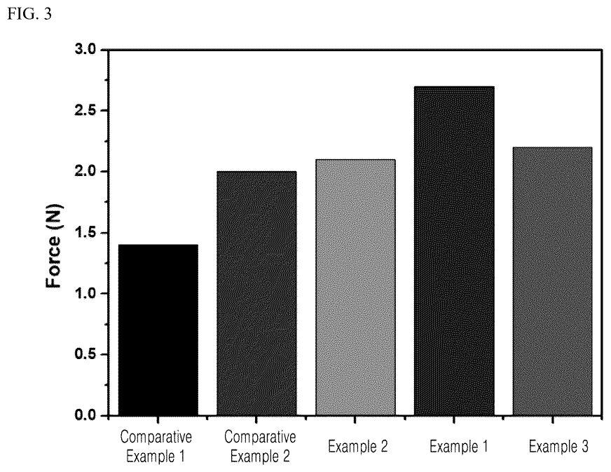

Next, in order to measure the adhesiveness between a current collector and a slurry in Comparative Examples and Examples, a peel-off evaluation of the electrode was performed using a universal testing machine (UTM). After a 3M tape was attached to the electrodes of Comparative Examples and Examples, a force required to remove the tape was measured using UTM equipment. The results are shown in FIG. 3.

Referring to FIG. 3, the data indicates that the adhesion was improved in Examples 1 to 3 compared to Comparative Examples 1 and 2.

Again without being limited by any mechanism, this improvement in the adhesive properties of the polymer may be due at least in part to an increase in hydrogen bonding sites when both polydopamine and glutathione are included.

### Experimental Example 2

In the experiment, the mechanical properties of Comparative Example 1 and Examples 1 to 3 were evaluated.

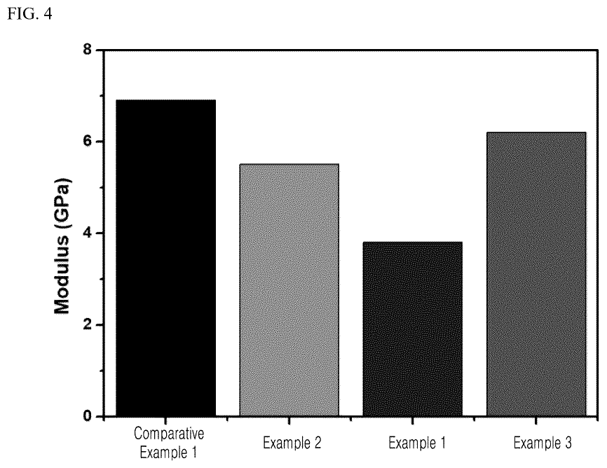

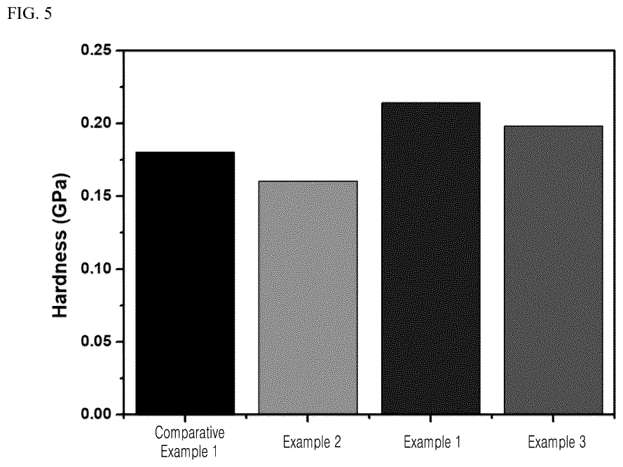

The elastic modulus values and hardness of Comparative Examples and Examples were measured, and the results are shown in FIGS. 4 and 5, respectively.

Referring to FIG. 4, it may be seen that Examples 1 to 3 have reduced modulus values compared to Comparative Examples. A lower modulus value means higher elasticity (flexibility), indicating that the elastic properties are better in Examples 1 to 3 that all further comprise additives.

Referring to FIG. 5, it may be seen that the hardness properties Example 2 are maintained at the level of Comparative Example 1 even though its elastic properties are improved in Example 2. In addition, the hardness results for Examples 1 and 3 are each improved relative to Comparative Example 1.

These results indicate that the Examples will have a positive effect on the electrochemical properties due to excellent hardness (or strength) properties as well as improved elastic properties.

### Experimental Example 3

In this experiment, the electrochemical properties were evaluated to confirm how effectively the binders used in Examples suppressed the volume expansion phenomenon in an electrode using only SiOx.

To this end, the capacities were measured while performing charging and discharging at charge and discharge rates of 0.5 C for Comparative Example 1 and Examples 1 to 3. (1 C=1400 mAh g⁻¹)

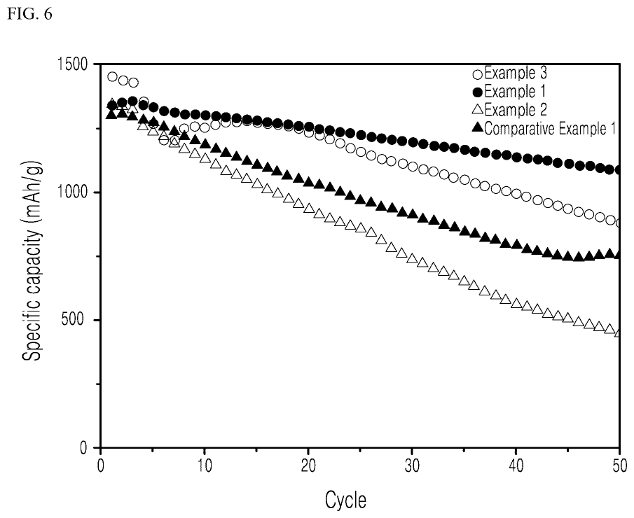

The results are shown in FIG. 6.

Referring to FIG. 6, the capacity characteristics of Examples 1 to 3 comprising the additive are better than that of Comparative Example 1. Thus, the presence of additive (e.g., polydopamine and glutathione), can be sufficient to suppress silicon volume expansion and relieve stress in the negative electrode.

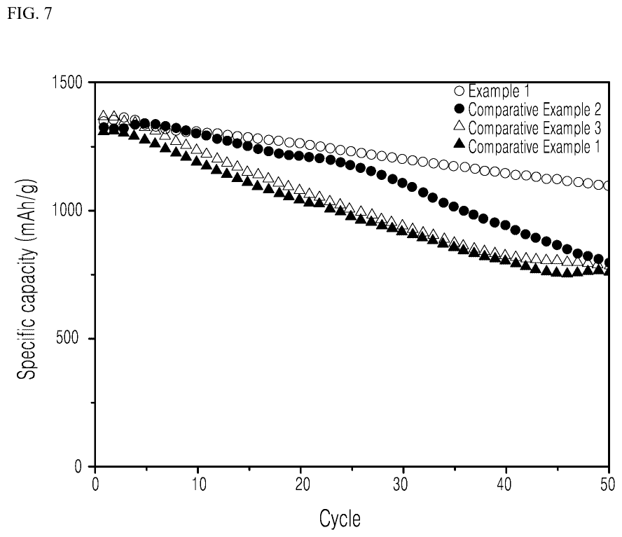

A comparison of the effects that the composition of the binder additive(s) has on the electrochemical properties of the electrode is shown in FIG. 7, including the electrode of Example 1 as compared with the electrodes of Comparative Examples 2 and 3 as well as Comparative Example 1.

As the data in FIG. 7 shows, the effects of suppressing silicon volume expansion and relieving stress are improved when both polydopamine and glutathione were included as a binder additive, relative to when polydopamine or glutathione was included alone.

### Experimental Example 4

In this experiment, Example 1, which had the best electrochemical performance measured in Experimental Example 3, was compared with Comparative Examples 1 and 4, and Example 4.

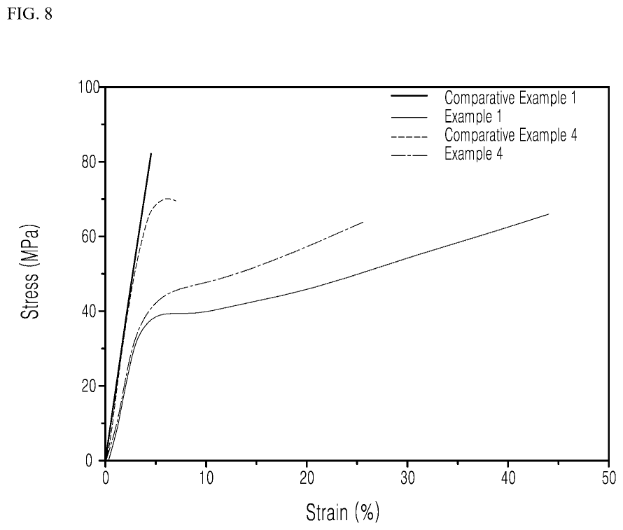

First, a tensile test was performed to evaluate the elastic properties of Examples 1 and 4, and Comparative Examples 1 and 4. The results are shown in FIG. 8.

The Stress-Strain graph of FIG. 8 shows that the elasticity of Example 4 was improved compared to Comparative Example 1, and the stress value was maintained at a higher value than Example 1. On the other hand, it was observed that the elasticity of Comparative Example 4 was substantially reduced, exhibiting poor elastic properties.

This data generally confirms that the elastic properties are significantly reduced when glutathione was included in an amount of at least twice (or more) than the amount of polydopamine.

The electrochemical properties of Examples 1 and 4 were also evaluated, with the capacities measured while performing charging and discharging at charge and discharge rates of 0.5 C. (1 C=1400 mAh g⁻¹).

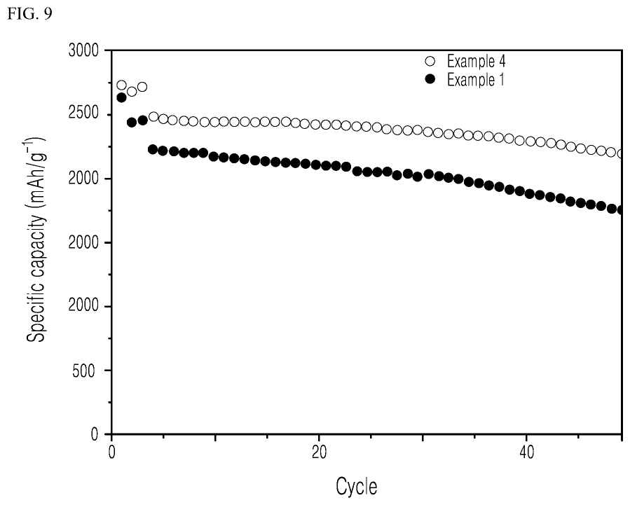

The results are shown in FIG. 9, and indicate that Example 4 has a capacity retention rate of 80.0% after 50 cycles, which has a better capacity characteristic than Example 1 (66.4%). Without being limited by theory, this result may be due at least in part by improved viscosity and mechanical strength caused by the increased content of polydopamine.

It is possible that increasing the content of polydopamine allows for an increase of the π-π interaction between the carbon material in the negative electrode active material and the styrene butadiene rubber in the binder, thereby showing more stable performance.

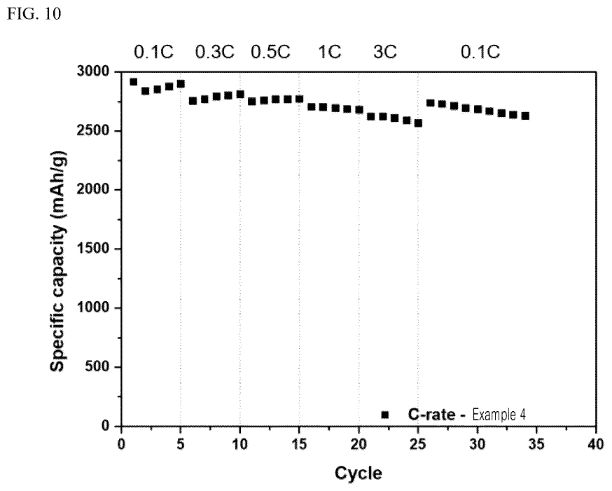

The rate characteristics of Example 4 with excellent capacity characteristics were evaluated, with the results shown in FIG. 10.

Referring to FIG. 10, Example 4 showed an excellent capacity retention rate even though the charge and discharge rates were increased from 0.1 C to 3 C. In addition, there was no significant decrease in capacity observed, even when the rate was returned to 0.1 C.

This data tends to show that, in the case of the composition as Example 4, the volume expansion of silicon may be effectively suppressed and relieved even under high-rate evaluation conditions.

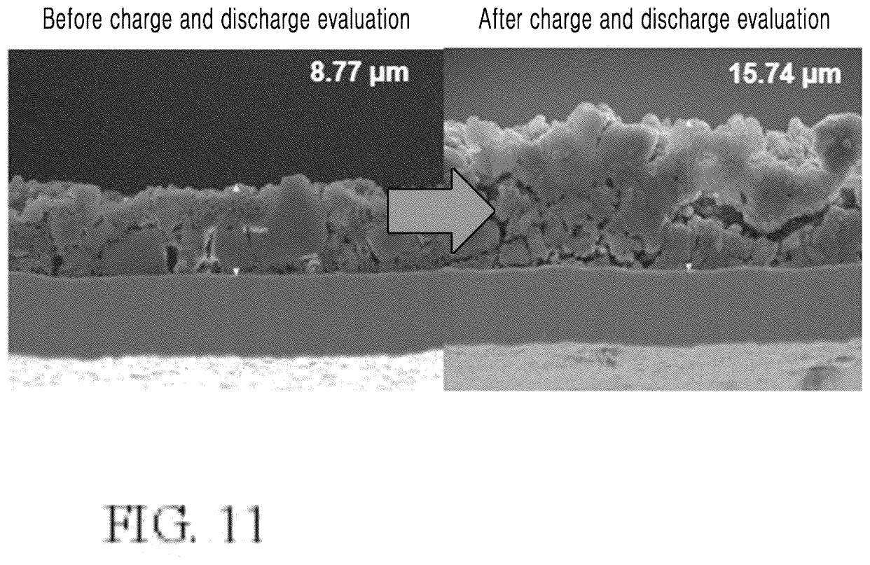

The volume expansion rate of Example 4 was observed by SEM images that were analyzed before and after the charge and discharge evaluation together with Comparative Example 1. The results are shown in FIG. 11.

In the case of Comparative Example 1, after the charge and discharge (50 cycles), detachment from the electrode occurred, making it impossible to observe the SEM image. In constrast, referring to FIG. 11, Example 4 had observable volume expansion where the thickness of the electrode increased from 8.77 μm to 15.74 μm.

This result was likely due at least in some part to the volume expansion of silicon due to repeated charge and discharge, with the volume expansion being approximately 79.5%. Thus, Example 4 is shown to have excellent adhesion and mechanical properties compared to Comparative Example 1 using only a commercial carboxymethylcellulose binder, and could effectively respond to the volume expansion of silicon.

### Experimental Example 5

In this experiment, the electrochemical properties of Example 5 and Comparative Example 5 were evaluated.

To this end, the electrodes of Example 5 and Comparative Example 5 were charged and discharged at a charge rate of 0.2 C and a discharge rate of 0.5 C, and the capacities and retention rates thereof were measured. (1 C=643 mAh g⁻¹).

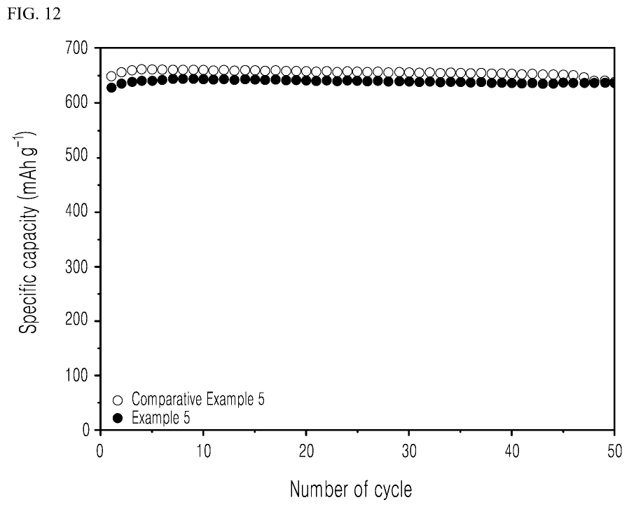

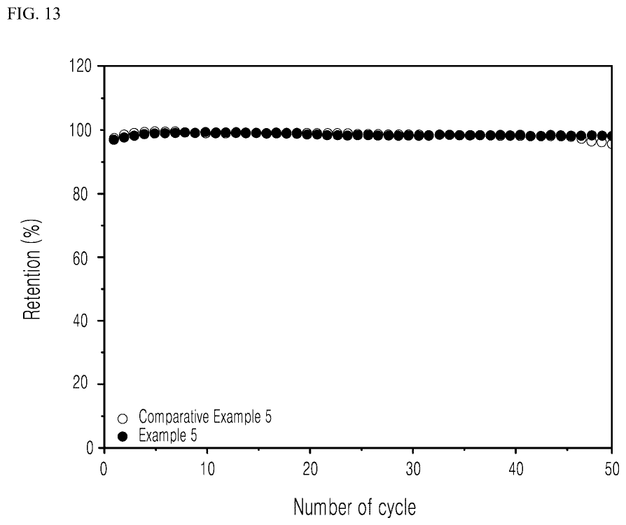

The results are illustrated in FIGS. 12 and 13, respectively.

Referring to FIGS. 12 and 13, the initial Coulombic Efficiency (ICE) of the electrode of Example 5 is 90.0%, which is similar to the electrode (88.7%) of Comparative Example 5 that includes a conventional commercialized binder composition. In addition, Example 5 had a very high capacity retention rate similar to the electrode of Comparative Example 5, indicating that the cycle characteristics were also excellent. This data confirms that a conventional commercialized binder can be replaced with the binder included in the electrode according to Example to manufacture an electrode that has both excellent mechanical properties and electrochemical properties.

The electrochemical properties were also evaluated for Example 5 and Comparative Example 5 by further increasing the charge/discharge rate.

Briefly, the electrodes of Example 5 and Comparative Example 5 were charged and discharged at a charge rate of 0.4 C and a discharge rate of 1.0 C, and the capacities and retention rates thereof were measured.

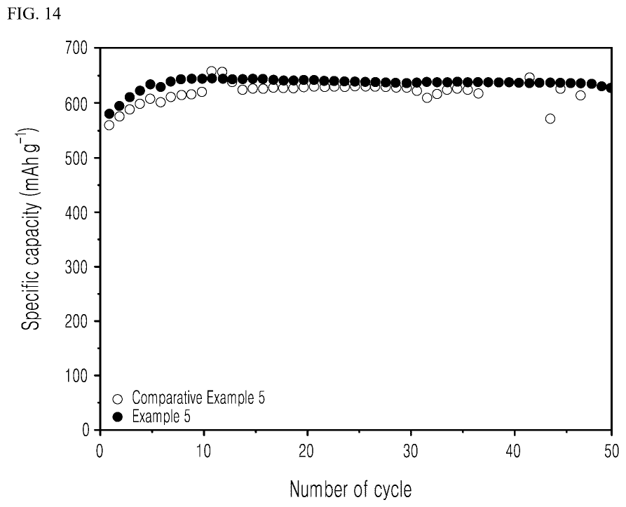

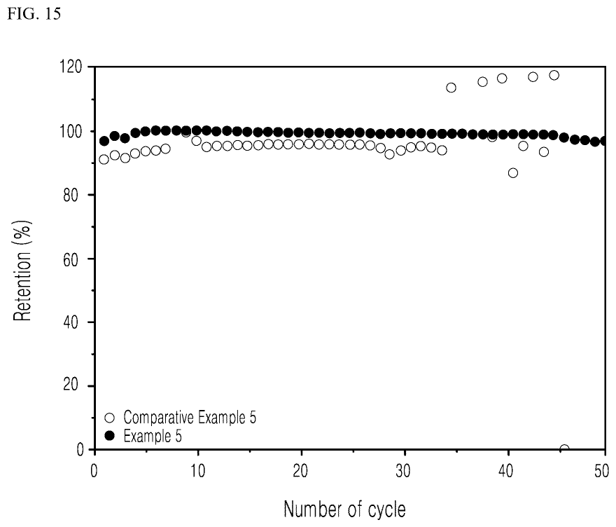

The results are illustrated in FIGS. 14 and 15, respectively.

Referring to FIGS. 14 and 15, the electrode of Comparative Example 5 with the conventional commercialized binder composition exhibits instability as the cycle progresses. In contrast, the electrode of Example 5 was stably driven up to 50 cycles and had a capacity retention rate of 96.8%, each excellent cycle characteristics. Thus, the improved electrochemical and mechanical properties associated with the binder of the Examples comprising polydopamine and glutathione demonstrate the potential of binders in accordance with the disclosure to replace conventional and commercially available binders.

### Experimental Example 6

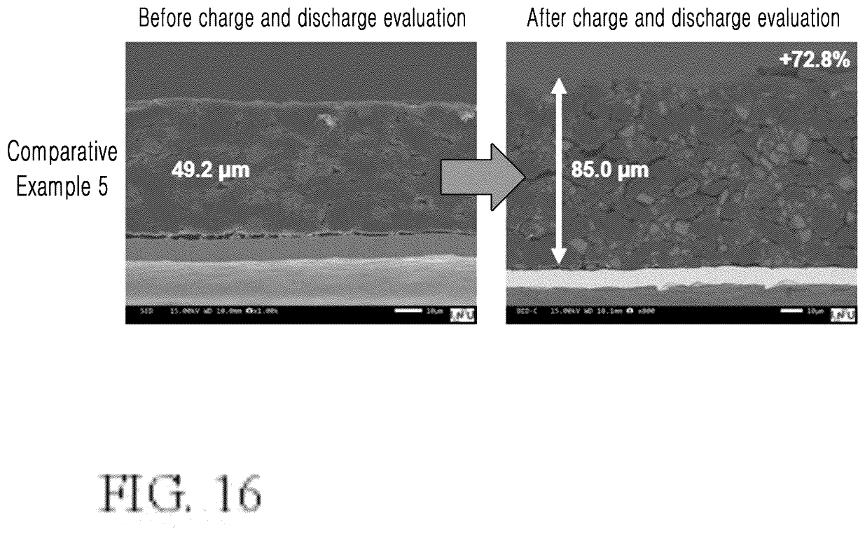

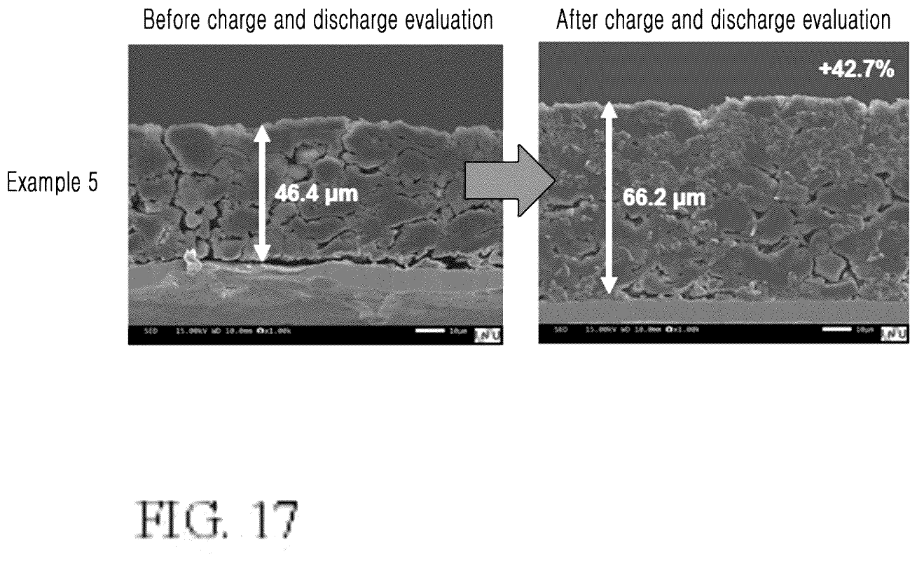

In this experiment, the SEM images before and after the charge/discharge evaluation of Comparative Example 5 and Example 5 were analyzed. The results are shown in FIGS. 16 and 17, respectively.

Referring to FIG. 16, Comparative Example 5 exhibited observable volume expansion with the thickness of the electrode increasing from 49.2 μm to 85.0 μm. This result is thought to be associated with the volume expansion of silicon due to repeated charge and discharge, with the volume expansion being 72.8% before and after the charge/discharge.

In contrast, referring to FIG. 17 Example 5 exhibited a reduced volume expansion rate of about 42.7% with the thickness of the electrode increasing from 46.4 μm to 66.2 μm. The data suggests that when each of the illustrative binder compositions according embodiments of the disclosure are included, it is possible to prevent electrode volume expansion associated with silicon, even after repeated charging and discharging.

The above Examples and experiments only serve to describe the present disclosure with reference to some non-limiting preferred embodiments. It will be understood by those skilled in the art that the present disclosure may be implemented with modified elements, steps, and forms without departing from the overall scope and spirit of the disclosure. Therefore, the particular embodiments disclosed herein should be considered merely as illustrative and not restrictive to the scope of the disclosure. The scope of the appended claims should not be interpreted to be limited by any of the foregoing description or embodiments, and encompass any equivalents thereof.

1. A binder composition for a lithium secondary battery negative electrode comprising:
carboxymethylcellulose (CMC); and
an additive comprising polydopamine (PDA) and glutathione (GT).

2. The binder composition of claim 1 comprising 5 to 20 wt % of the additive based on the total binder composition weight.

3. The binder composition of claim 1, wherein the polydopamine (PDA) and the glutathione (GT) are included in a weight ratio of 1:1.5 to 2:1 (PDA: GT).

4. The binder composition of claim 1, further comprising:
styrene butadiene rubber (SBR).

5. A lithium secondary battery negative electrode comprising:
a binder comprising the binder composition according to claim 1;
a conductive material; and
a negative electrode active material.

6. The lithium secondary battery negative electrode of claim 5, wherein the binder further comprises styrene butadiene rubber (SBR).

7. The lithium secondary battery negative electrode of claim 6, wherein the binder comprises the binder composition and the styrene butadiene rubber (SBR) in a molar ratio of 1:1 to 1:3 (binder composition: SBR).

8. The lithium secondary battery negative electrode of claim 5, wherein the negative electrode active material comprises silicon oxide (SiOx).

9. The lithium secondary battery negative electrode of claim 8, wherein the negative electrode active material further comprises at least one carbon material comprising silicon carbide (SiC), artificial graphite (AG), and/or natural graphite (NG).

10. The lithium secondary battery negative electrode of claim 5, wherein the conductive material comprises at least one of carbon black (CB) and/or single-walled carbon nanotubes (SWCNT).

11. A lithium secondary battery comprising the lithium secondary battery negative electrode according to claim 5.

12. A lithium secondary battery comprising the binder composition according to claim 1.

13. A lithium secondary battery comprising the binder composition according to claim 2.

14. A lithium secondary battery comprising the binder composition according to claim 3.

15. A lithium secondary battery comprising the binder composition according to claim 4.

16. A lithium secondary battery comprising the lithium secondary battery negative electrode according to claim 6.

17. A lithium secondary battery comprising the lithium secondary battery negative electrode according to claim 7.

18. A lithium secondary battery comprising the lithium secondary battery negative electrode according to claim 8.

19. A lithium secondary battery comprising the lithium secondary battery negative electrode according to claim 9.

20. A lithium secondary battery comprising the lithium secondary battery negative electrode according to claim 10.
